(19) United States
(12) Patent Application Publication
(10) Pub. No.: US 2020/0177798 A1
(43) Pub. Date: Jun. 4, 2020

(54) Machine Learning of Environmental Conditions to Control Positioning of Visual Sensors

(71) Applicant: NVIDIA Corporation, Santa Clara, CA (US)

(72) Inventors: Hardik Jagdishbhai Parekh, Pune (IN); Sonakshi Agarwal, Pune (IN)

(21) Appl. No.: 16/208,130

(22) Filed: Dec. 3, 2018

(51) Int. Cl. H04N 5/232; G06K 9/62; H04N 7/18; G05D 1/00; B60R 1/00; G05D 1/02; G06N 20/00

(52) U.S. Cl. CPC H04N 5/23222; G06K 9/6262; H04N 5/23299; H04N 7/181; B60R 2300/30; B60R 1/00; G05D 1/0246; G06N 20/00; G05D 2201/0213; G05D 1/0088

(57) ABSTRACT

Systems, methods, and computer program products are provided for controlling positioning of visual sensors based on machine learned environmental conditions. One or more machine learning models are performed to determine environmental conditions based on receiving one or more visual sensor inputs. Position of one or more visual sensors are further caused to be changed in order to optimize visual sensing by the one or more visual sensors of visual information relevant to the environmental conditions.

### TECHNICAL FIELD

One embodiment relates to positioning of visual sensors for visual sensing.

### BACKGROUND

The output of visual sensors, such as cameras or other image/video collectors, can be used by many applications that require a visual indication of environmental conditions. For example, currently, autonomous and some non-autonomous vehicles are equipped with cameras that capture images, or video frames, of a surrounding environment. The output from these cameras can be provided to an occupant of the vehicle to make driving decisions and/or to an artificial intelligence (AI) network to make autonomous driving decisions. However, the extent to which visual sensors can capture environmental conditions is inherently limited according to the positioning of the visual sensors, which has traditionally been fixed or manually adjustable. There is a need for addressing these issues and/or other issues associated with the prior art.

### BRIEF DESCRIPTION OF THE DRAWINGS

FIG. 1 illustrates a flowchart of a method for controlling positioning of visual sensors based on machine learned environmental conditions, in accordance with one embodiment.

FIG. 2A illustrates a block diagram of a subsystem that uses machine learning to determine environmental conditions, in accordance with one embodiment.

FIG. 2B illustrates a block diagram of a subsystem that controls positioning of visual sensors based on machine learned environmental conditions, in accordance with one embodiment.

FIG. 3 illustrates a flowchart of a method for outputting visual information sensed by visual sensors positioned based on machine learned environmental conditions, in accordance with one embodiment.

FIG. 4A illustrates exemplary environmental conditions that include road conditions causing repositioning of visual sensors on a vehicle, in accordance with one embodiment.

FIG. 4B illustrates a location of the visual sensors on the vehicle, in accordance with one embodiment.

FIGS. 4C-D illustrate a flowchart of a method for controlling positioning of visual sensors located on a vehicle based on machine learned environmental conditions for the vehicle, in accordance with one embodiment.

FIG. 5 illustrates a parallel processing unit, in accordance with one embodiment.

FIG. 6A illustrates a general processing cluster within the parallel processing unit of FIG. 5, in accordance with one embodiment.

FIG. 6B illustrates a memory partition unit of the parallel processing unit of FIG. 5, in accordance with one embodiment.

FIG. 7A illustrates the streaming multi-processor of FIG. 6A, in accordance with one embodiment.

FIG. 7B is a conceptual diagram of a processing system implemented using the PPU of FIG. 5, in accordance with one embodiment.

FIG. 7C illustrates an exemplary system in which the various architecture and/or functionality of the various previous embodiments may be implemented.

FIG. 8 illustrates is a conceptual diagram of a graphics processing pipeline implemented by the PPU of FIG. 5, in accordance with an embodiment.

### DETAILED DESCRIPTION

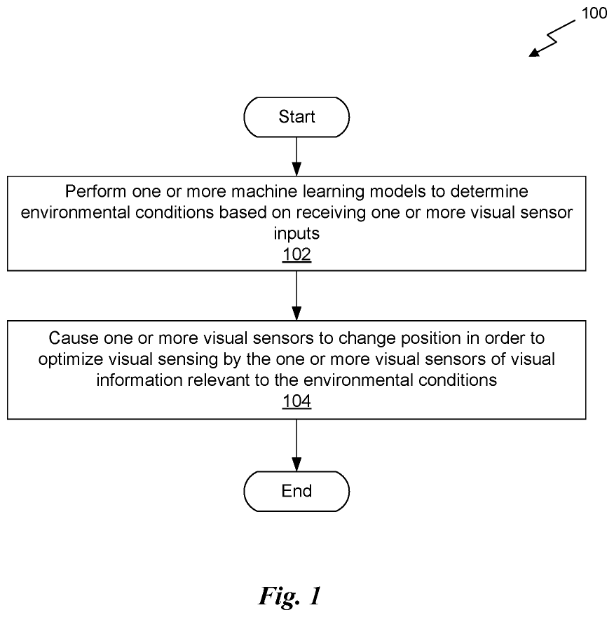

FIG. 1 illustrates a flowchart of a method 100 for controlling positioning of visual sensors based on machine learned environmental conditions, in accordance with one embodiment. In one embodiment, the method 100 may be performed by one or more processing units, and/or may also be performed by a program, custom circuitry, or by a combination thereof. In one embodiment, the method 100 may be executed by a GPU (graphics processing unit), CPU (central processing unit), or any processor capable of performing arithmetic computations, such as those described below with reference to one or more of the remaining Figures. Furthermore, persons of ordinary skill in the art will understand that any system that performs method 100 is within the scope and spirit of embodiments described herein.

In operation 102, one or more machine learning models are performed to determine environmental conditions based on receiving one or more visual sensor inputs. In operation 104, one or more visual sensors are caused to change position in order to optimize visual sensing by the one or more visual sensors of visual information relevant to the environmental conditions.

In one embodiment, the one or more visual sensor inputs are received from the one or more visual sensors. In one embodiment, the one or more visual sensor inputs are received from one or more other visual sensors that are different from the one or more visual sensors whose position is caused to be changed. In one embodiment, the one or more other visual sensors may be located in close proximity to the one or more visual sensors for providing visual sensor inputs that are useful in determining environmental conditions relevant to one or more visual sensors.

In one embodiment, the one or more visual sensors and/or the one or more other visual sensors may include one or more cameras, lidar sensors, radar sensors, and/or any other sensors capable of sensing visual information. In one embodiment, the one or more visual sensor inputs may be images, video frames, and/or any other visual data usable to determine environmental conditions. In one embodiment, the one or more visual sensor inputs include one or more images, video frames, etc. of an environment surrounding, or partially surrounding, the one or more visual sensors.

As noted above with respect to operation 102, one or more machine learning models are performed to determine the environmental conditions based on receiving the one or more visual sensor inputs. In one embodiment, the one or more visual sensor inputs may be input to the one or more machine learning models, and the environmental conditions may be received as output from the one or more machine learning models. In one embodiment, the one or more machine learning models may be trained using training data to learn environmental conditions from visual sensor inputs. In one embodiment, the environmental conditions include a state of an environment surrounding, or partially surrounding, the one or more visual sensors.

As noted above with respect to operation 104, the one or more visual sensors are caused to change position in order to optimize visual sensing by the one or more visual sensors of visual information relevant to the environmental conditions determined using the one or more machine learning models. In one embodiment, the one or more visual sensors change position rotationally and/or linearly. Thus, in one embodiment, the one or more visual sensors are movable from a current position in a rotational and/or linear manner.

In one embodiment, an optimal position for the one or more visual sensors is determined, based on the environmental conditions, where the optimal position is one which optimizes visual sensing by the one or more visual sensors of visual information relevant to the environmental conditions. In one embodiment, the visual sensing by the one or more visual sensors of the visual information relevant to the environmental conditions includes capturing visual data (e.g. images, video frames, etc.) relevant to the environmental conditions, such as visually capturing the environmental conditions, or certain aspects, features, etc. of the environmental conditions. Thus, the one or more visual sensors may be positioned to be able to optimally capture at least a portion of the environmental conditions.

In one embodiment, the optimal position for the one or more visual sensors is determined using one or more additional machine learning models. In one embodiment, the one or more additional machine learning models may be trained to learn the optimal position for the one or more visual sensors based on environmental conditions. In one embodiment, the one or more visual sensors are caused to change from a current position to the optimal position. By positioning the one or more visual sensors based on machine learned environmental conditions, the one or more visual sensors are positioned to optimally sense the visual information relevant to the environmental conditions.

It should be noted that the method 100 may be repeated at continuous intervals, upon receiving updated visual sensor inputs, and/or responsive to specified events. In this way, as environmental conditions may change, the method 100 may be used to reposition the one or more visual sensors as necessary to optimize visual sensing by the one or more visual sensors of visual information relevant to current environmental conditions.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

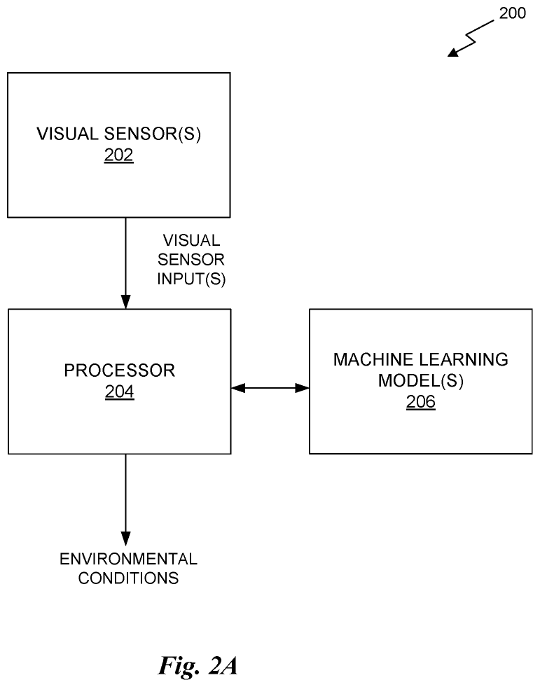

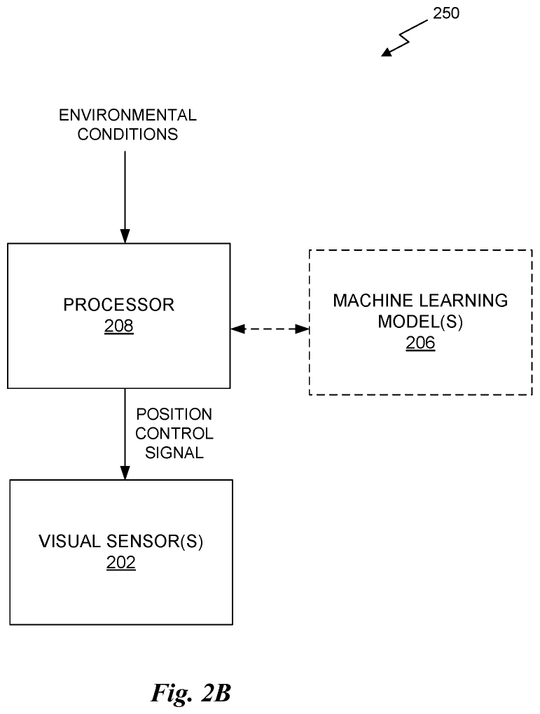

FIG. 2A illustrates a block diagram of a subsystem 200 that uses machine learning to determine environmental conditions, in accordance with one embodiment. As an option, the subsystem 200 may be implemented in the context of any one or more of the embodiments set forth in any previous and/or subsequent figure(s) and/or description thereof. For example, in one embodiment, the subsystem 200 may be used to implement operation 102 of the method 100 of FIG. 1. However, it is to be appreciated that the subsystem 200 may be implemented in the context of any desired environment.

As shown, the subsystem 200 includes one or more visual sensors 202 in communication (e.g. wired or wirelessly) with a processor 204. The one or more visual sensors 202 provide one or more visual sensor inputs to a processor 204. In one embodiment, the one or more visual sensor inputs include one or more images, video frames, etc. of an environment surrounding, or partially surrounding, the one or more visual sensors 202.

As also shown, the processor 204 is in communication with one or more machine learning models 206. The processor 204 may use the one or more machine learning models 206 to determine environmental conditions based on the receipt of the one or more visual sensor inputs. The environmental conditions may include a state of an environment surrounding, or partially surrounding, the one or more visual sensors 202. In one embodiment, the processor 204 may input the one or more visual sensor inputs to the one or more machine learning models 206, and the one or more machine learning models 206 may output an indication of the environmental conditions to the processor 204. In one embodiment, the one or more machine learning models 206 may be trained to learn the environmental conditions from the visual sensor inputs.

As further shown, the processor 204 outputs the environmental conditions. For example, the processor 204 may output the environmental conditions as described below with reference to FIG. 2B.

FIG. 2B illustrates a block diagram of a subsystem 250 that controls positioning of visual sensors based on machine learned environmental conditions, in accordance with one embodiment. As an option, the subsystem 250 may be implemented in the context of any one or more of the embodiments set forth in any previous and/or subsequent figure(s) and/or description thereof. For example, in one embodiment, the subsystem 250 may be used to implement operation 104 of the method 100 of FIG. 1. However, it is to be appreciated that the subsystem 200 may be implemented in the context of any desired environment.

As shown, a processor 208 receives environmental conditions. In one embodiment, the processor 208 may receive the environmental conditions from processor 204 of FIG. 2A. It should be noted that while the processor 208 is shown as separate from the processor 204 of FIG. 2A, alternatively the functionality described herein with respect to processor 208 may be performed by processor 204 of FIG. 2A.

The processor 208 outputs one or more position control signals to one or more visual sensors 202, based on the received environmental conditions. It should be noted that while the one or more position control signals are shown as being output to the one or more visual sensors 202 from FIG. 2A, alternatively one or more position control signals may be output to one or more other visual sensors to which the environmental conditions are relevant (e.g. in close proximity to the one or more visual sensors 202). In the context of the present embodiment, the one or more position control signals cause the one or more visual sensors 202 to change position in order to optimize visual sensing by the one or more visual sensors 202 of visual information relevant to the environment conditions.

In one embodiment, the position control signals to send to the one or more visual sensors 202 may be determined by the processor 208 using one or more machine learning models 210. The one or more machine learning models 210 may be trained to learn an optimal position for the one or more visual sensors based on the environmental conditions. Based on receipt of the optimal position from the one or more machine learning models 210, the processor 208 may configure position control signals to send to the one or more visual sensors 202 to change a current position of the one or more visual sensors 202 to the optimal position output by the one or more machine learning models 210. Of course, in one embodiment, the position control signals to send to the one or more visual sensors 202 may be determined by the processor 208 without use of the one or more machine learning models 210, but alternatively using another type of algorithm, computer code, etc.

Upon receipt of the one or more position control signals by the one or more visual sensors 202, a position of the one or more visual sensors 202 is changed. For example, a controller of the one or more visual sensors 202 may receive the position control signals and change a current position of the one or more visual sensors 202 accordingly. Thus, the controller may be adapted to control moveable, or repositionable, hardware of the one or more visual sensors 202 based on the position control signals. Once the position of the one or more visual sensors 202 is changed, visual sensing by the one or more visual sensors 202 of visual information relevant to the environment conditions is optimized (e.g. for the environmental conditions).

In one embodiment, a third processor (not shown) may be included to receive, from the one or more visual sensors 202 in the changed position, the visual information relevant to the environmental conditions, and to further output the visual information. In one embodiment, the visual information may be output by being displayed to a user. In one embodiment, the visual information may be output to an automated system that makes a decision based on the visual information, such as to a computer program, machine learning model, deep learning network, etc.

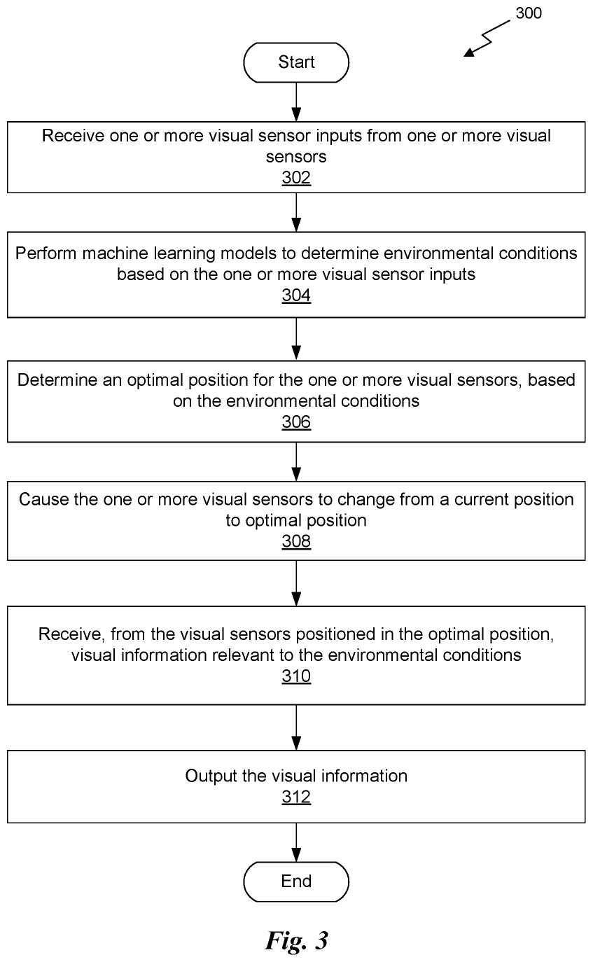

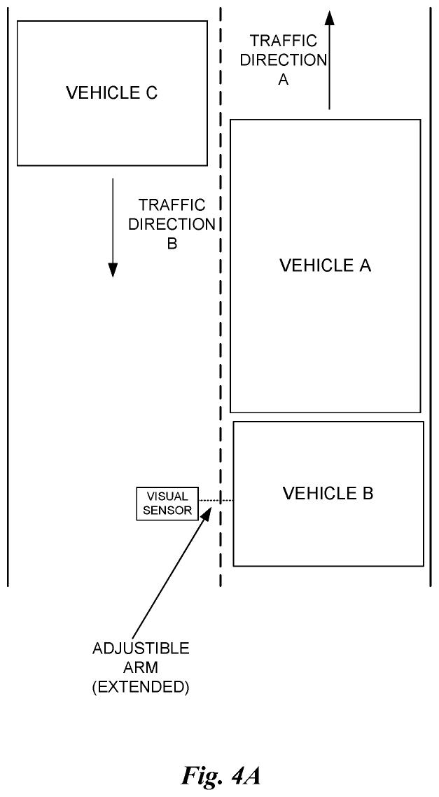

FIG. 3 illustrates a flowchart of a method 300 for outputting visual information sensed by visual sensors positioned based on machine learned environmental conditions, in accordance with one embodiment. As an option, the method 300 may be carried out in the context of any one or more of the embodiments set forth in any previous and/or subsequent figure(s) and/or description thereof. For example, in one embodiment, the subsystems 200 and 250 may be used to carry out the present method 300. However, it is to be appreciated that the method 300 may be carried out in the context of any desired environment.

In operation 302, one or more visual sensor inputs are received from one or more visual sensors. In operation 304, one or more machine learning models are performed to determine environmental conditions based on the one or more visual sensor inputs. In operation 306, an optimal position for the one or more visual sensors is determined, based on the environmental conditions. For example, the optimal position may enable the one or more visual sensors to optimally sense visual information relevant to the environmental conditions.

In operation 308, a current position of one or more visual sensors is caused to change to the optimal position. In operation 310, visual information relevant to the environmental conditions is received from the one or more visual sensors positioned in the optimal position. The visual information may be images, video frames, or any other visual data sensed by the one or more visual sensors that capture one or more aspects of an environment surrounding the one or more visual sensors.

In operation 312, the visual information is output. In one embodiment, the visual information may be output by being displayed to a user. Accordingly, the user may make a decision based on the visual information. In one embodiment, the visual information may be output to an automated system that makes a decision based on the visual information, such as to a computer program, machine learning model, deep learning network, etc.

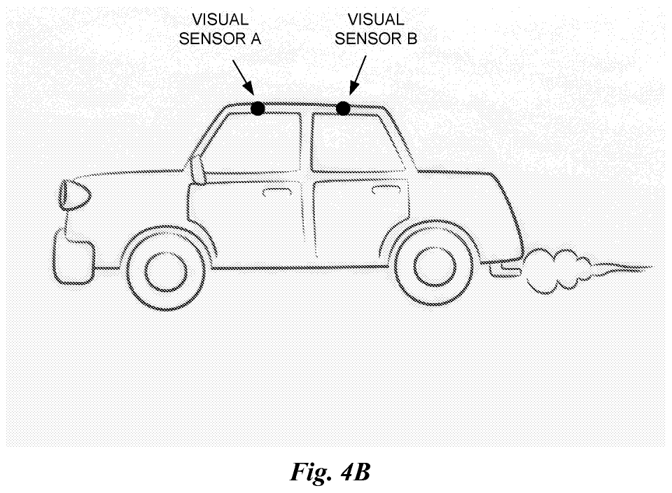

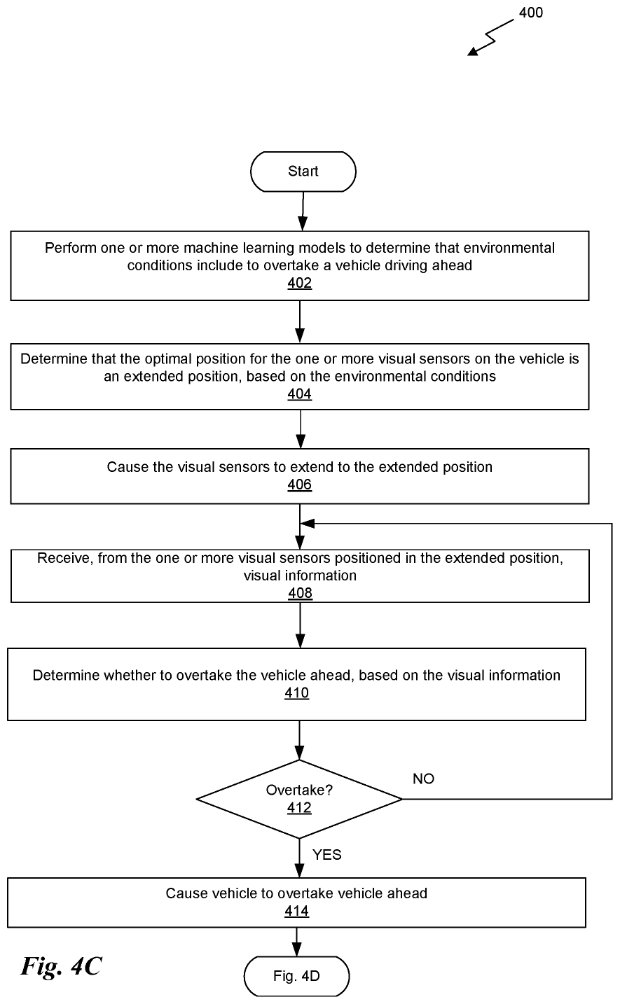

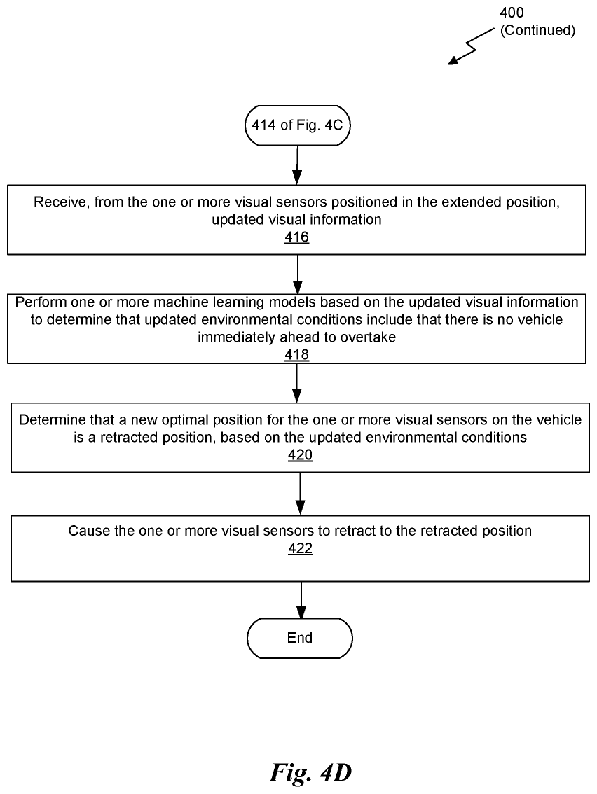

FIG. 4A illustrates exemplary environmental conditions causing repositioning of visual sensors on a vehicle, in accordance with one embodiment. For example, the environmental conditions may be road conditions (e.g. a state of a road on which the vehicle is traveling as described below), which is one example of the environmental conditions set forth in any previous and/or subsequent figure(s) and/or description thereof.

As shown, a two-lane roadway includes a first lane with traffic moving in direction A and a second lane traffic moving in direction B. The two-lane roadway includes a dashed center line indicating that it is legal for a car, driving in a one lane with traffic in one direction and behind a second vehicle, to use the other lane with traffic driving in the opposite direction in order to overtake (or pass) the second vehicle.

In the example shown, Vehicle B, equipped with one or more movable visual sensors, is traveling behind Vehicle A in the first lane. Vehicle C is traveling in the second lane. The visual sensors on Vehicle B generate visual sensor input that indicates one or more aspects of an environment surrounding Vehicle B. For example, the visual sensors may generate visual sensor input (e.g. images, etc.) that indicate the existence of the two-lane roadway that allows passing as mentioned above, the existence of Vehicle A, and optionally other environmental aspects.

Due to the size of Vehicle A, or other factors, the visual sensors on Vehicle B may be unable to sense Vehicle C. For example, a current position of the visual sensors may prevent the visual sensors from sensing Vehicle C. This means that the driver of Vehicle B, or an autonomous driving system of Vehicle B, cannot decide whether it is safe to enter the second lane with oncoming traffic in order to pass Vehicle A.

To overcome this limitation of the visual sensors, the visual sensor input is input to one or more machine learning models that determine environmental conditions for Vehicle B. The environmental conditions may indicate a scenario in which Vehicle B may want to pass Vehicle A using the second lane with oncoming traffic. Based on the determined environmental conditions, the current position of the visual sensors on Vehicle B may be caused to change to an optimal position that optimizes visual sensing of visual information relevant to the environmental conditions. In one embodiment, the visual sensors may be moved to a position that allows the visual sensors to sense a state of the first lane, including specifically that Vehicle C is approaching the section of road adjacent to Vehicle B.

In the embodiment shown, the visual sensors are moved linearly, by extending one or more adjustable arms of the visual sensors. Once in the optimal position, the visual sensors sense visual information relevant to the environmental conditions, such as the position of Vehicle C as approaching the section of road adjacent to Vehicle B. The visual information may be output to a driver of Vehicle B, or to an autonomous driving system of Vehicle B, for deciding whether to enter the second lane with oncoming traffic in order to pass Vehicle A. In the embodiment shown, since the visual information may indicate the position of Vehicle C as approaching the section of road adjacent to Vehicle B, it may be decided not to enter the second lane with oncoming traffic in order to pass Vehicle A.

Further, the visual information may be received as new visual sensor input to determine updated environmental conditions using the one or more machine learning models. The updated environmental conditions may include that Vehicle C is within a certain distance of approaching a section of road adjacent to Vehicle B. Based on the updated environmental conditions, the current position of the visual sensors on Vehicle B may be caused to change to a new position. For example, the visual sensors may be moved linearly, by retracting the one or more adjustable arms of the visual sensors. This new position may secure the visual sensors from being struck by Vehicle C as it adjacently passes Vehicle B while driving in the opposite direction.

To this end, by using the machine learned environmental conditions, the visual sensors may be optimally positioned to provide visual information that aids in making driving decisions related to overtaking a vehicle ahead. Of course, it should be noted that the visual sensors may be optimally positioned based on machine learned environmental conditions to aid in making other driving decisions, whether made manually by the driver or autonomously by an autonomous driving system, such as changing lanes, parking, speed controls, giving priority on the road to certain types of vehicles (e.g. ambulance, policy, etc.) by avoiding overtaking these vehicles on the road or avoiding transitioning to a lane that would interfere with a driving path these vehicles.

FIG. 4B illustrates a location of the visual sensors on the vehicle, in accordance with one embodiment. For example, the vehicle shown may be Vehicle B of FIG. 4A, in one embodiment. It should be noted that the location of the visual sensors on the vehicle are set forth for illustrative purposes only, and in one embodiment may depend on the model and/or make of the vehicle.

As shown, Vehicle B is equipped with two visual sensors located thereon, Visual sensor A and Visual sensor B. One or both of the Visual sensor A and Visual sensor B are movable with respect to the vehicle. For example, Visual sensor A and/or Visual sensor B may be rotationally (e.g. 360 degrees) or linearly (e.g. by extension arm in any direction) movable with respect to the vehicle.

Visual sensor A is located on a forward portion of the vehicle, such as on a side panel of the forward portion. Visual sensor B is located on a back portion of the vehicle, such as on a side panel of the back portion. In one embodiment, additional visual sensors may be located on an opposite side panel of the vehicle (not shown). The visual sensors may be powered by a battery of the vehicle, in one embodiment.

FIGS. 4C-D illustrate a flowchart of a method 400 for controlling positioning of visual sensors located on a vehicle based on machine learned environmental conditions for the vehicle, in accordance with one embodiment. As an option, the method 400 may be carried out in the context of any one or more of the embodiments set forth in any previous and/or subsequent figure(s) and/or description thereof. For example, in one embodiment, the 400 may be carried out in the context of Vehicle B of FIG. 4A. However, it is to be appreciated that the method 400 may be carried out in the context of any desired environment.

In the context of the present method 400, autonomous driving for the vehicle is active for controlling driving of the vehicle. In one embodiment, the vehicle may have an autonomous driving system installed thereon for controlling the driving of the vehicle. In operation 402, one or more machine learning models are performed to determine that environmental conditions include to overtake (or pass via an adjacent lane of traffic) a vehicle driving ahead. In particular, visual sensor input captured by one or more visual sensors located on the vehicle is used by the one or more machine learning models determine that environmental conditions include to overtake a vehicle driving ahead.

In operation 404, it is determined that an optimal position for the one or more visual sensors on the vehicle is an extended position, based on the environmental conditions. The determination of the optimal position may be made by inputting the environmental conditions to one or more additional machine learning models, in one embodiment. In the context of the environmental conditions including to overtake a vehicle driving ahead, the optimal position for the one or more visual sensors is the extended position so that the one or more visual sensors are able to optimally capture visual information related to overtaking the vehicle driving ahead.

In operation 406, the one or more visual sensors are caused to extend to the extended position. For example, a position control signal may be sent to the one or more visual sensors to cause the one or more visual sensors to extend from the vehicle a defined amount. In one embodiment, the position control signal may also instruct a defined amount of rotation for the one or more visual sensors.

In operation 408, visual information is received from the one or more visual sensors positioned in the extended position. Based on the visual information, it is determined in operation 410 whether to overtake the vehicle ahead. In particular, the autonomous driving system for the vehicle, or more generally a processor, may use the visual information to determine whether to overtake the vehicle ahead.

Decision 412 determines whether the determination in operation 410 is to overtake the vehicle ahead. If decision 412 is that the determination in operation 410 is not to overtake the vehicle ahead, the method 400 returns to operation 408 where updated visual information is received from the one or more visual sensors positioned in the extended position in order to again determine in operation 410, from the updated visual information, whether to overtake the vehicle ahead.

If decision 412 is that the determination in operation 410 is to overtake the vehicle ahead, the method 400 proceeds to operation 414 where the vehicle is caused to overtake the vehicle ahead. For example, the autonomous driving system for the vehicle may cause the vehicle to overtake the vehicle ahead using an adjacent lane of traffic.

With continuing reference to the method 400 as shown in FIG. 4D, from operation 414 the method 400 proceeds to operation 416 where updated visual information is received from the one or more visual sensors. The updated visual information may be received in response to the vehicle overtaking the vehicle ahead, in one embodiment. In operation 418, the one or more machine learning models are performed based on the updated visual information to determine that updated environmental conditions include that there is no vehicle immediately ahead that needs to be overtaken.

In operation 420, it is determined that a new optimal position for the one or more visual sensors on the vehicle is a retracted position, based on the updated environmental conditions. The determination of the new optimal position may be made by inputting the updated environmental conditions to the one or more additional machine learning models, in one embodiment. In the context of the environmental conditions including that there is no vehicle immediately ahead that needs to be overtaken, the new optimal position for the one or more visual sensors is the retracted position.

In operation 422, the one or more visual sensors are caused to retract to the retracted position. For example, a position control signal may be sent to the one or more visual sensors to cause the one or more visual sensors to retract towards the vehicle a defined amount, or to a default retracted position. In one embodiment, the position control signal may also instruct a defined amount of rotation for the one or more visual sensors (e.g. to a default rotational position).

While the method is shown as ending after operation 422, it should be understand that the one or more visual sensors may repeatedly to provide visual information from which environmental conditions can be determined for use in positioning the one or more visual sensors in a manner that is optimal with respect to the environmental conditions.

### Parallel Processing Architecture

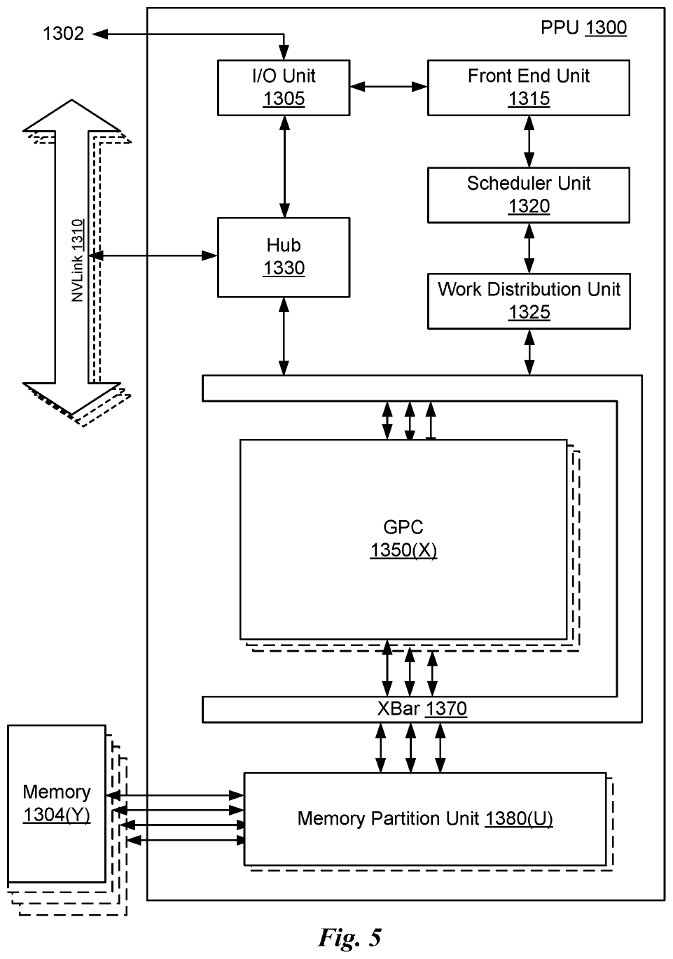

FIG. 5 illustrates a parallel processing unit (PPU) 1300, in accordance with an embodiment. In an embodiment, the PPU 1300 is a multi-threaded processor that is implemented on one or more integrated circuit devices. The PPU 1300 is a latency hiding architecture designed to process many threads in parallel. A thread (e.g., a thread of execution) is an instantiation of a set of instructions configured to be executed by the PPU 1300. In an embodiment, the PPU 1300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 1300 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 1300 may be configured to accelerate thousands of High Performance Computing (HPC), data center, and machine learning applications. The PPU 1300 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the PPU 1300 includes an Input/Output (I/O) unit 1305, a front end unit 1315, a scheduler unit 1320, a work distribution unit 1325, a hub 1330, a crossbar (Xbar) 1370, one or more general processing clusters (GPCs) 1350, and one or more memory partition units 1380. The PPU 1300 may be connected to a host processor or other PPUs 1300 via one or more high-speed NVLink 1310 interconnect. The PPU 1300 may be connected to a host processor or other peripheral devices via an interconnect 1302. The PPU 1300 may also be connected to a local memory comprising a number of memory devices 1304. In an embodiment, the local memory may comprise a number of dynamic random access memory (DRAM) devices. The DRAM devices may be configured as a high-bandwidth memory (HBM) subsystem, with multiple DRAM dies stacked within each device.

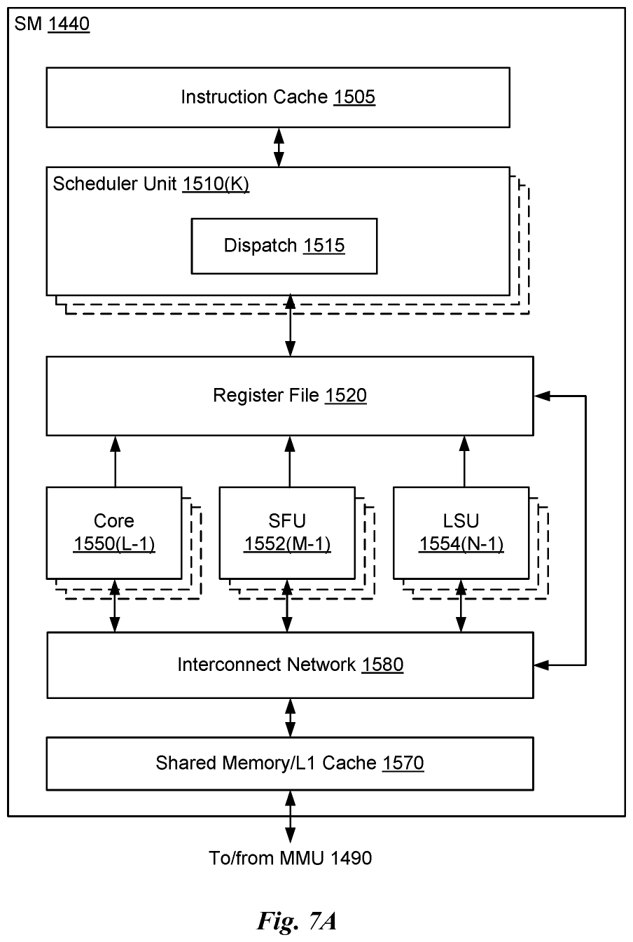

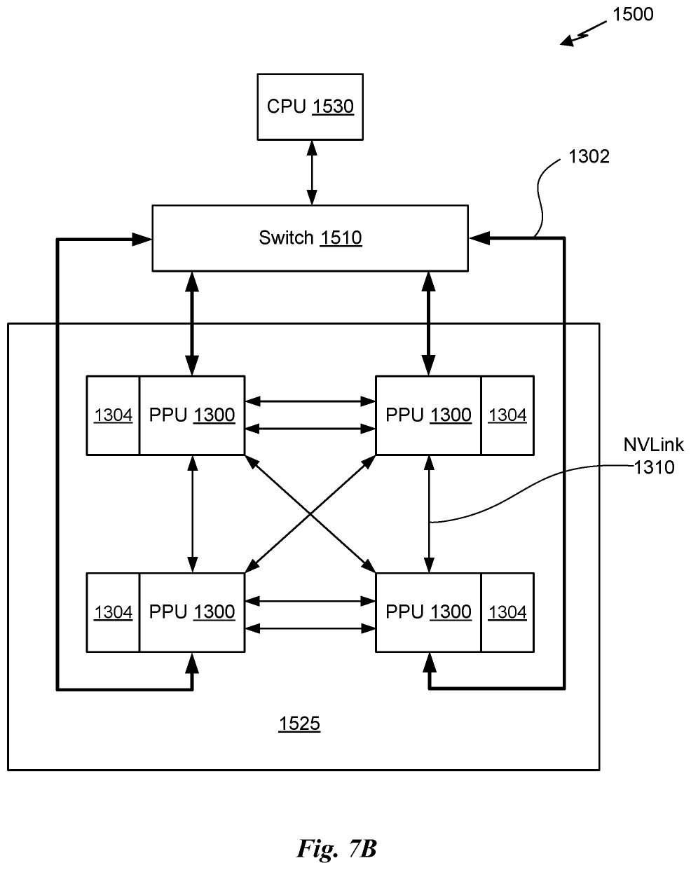

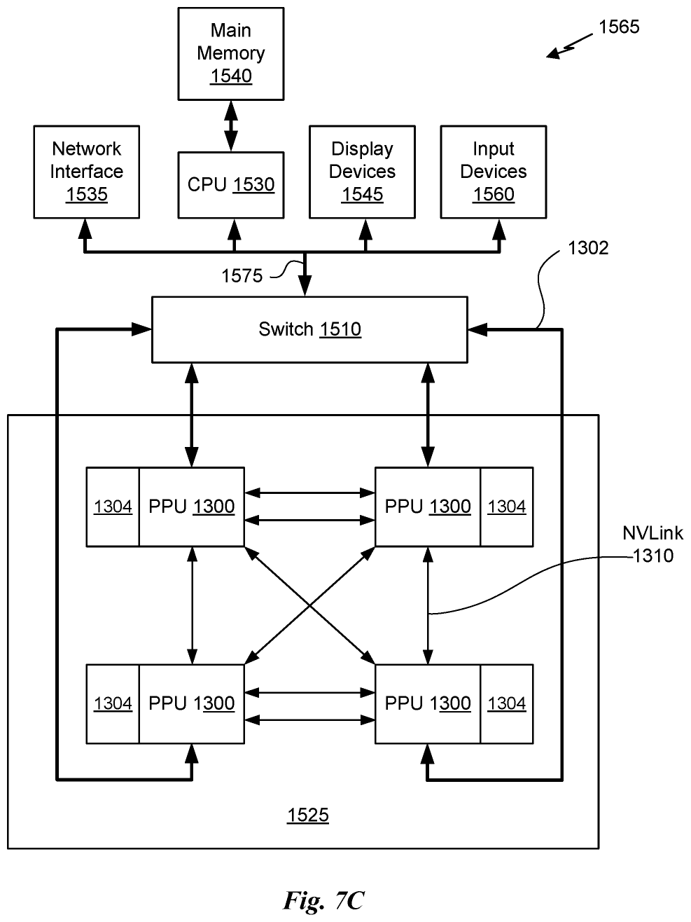

The NVLink 1310 interconnect enables systems to scale and include one or more PPUs 1300 combined with one or more CPUs, supports cache coherence between the PPUs 1300 and CPUs, and CPU mastering. Data and/or commands may be transmitted by the NVLink 1310 through the hub 1330 to/from other units of the PPU 1300 such as one or more copy engines, a video encoder, a video decoder, a power management unit, etc. (not explicitly shown). The NVLink 1310 is described in more detail in conjunction with FIG. 7B.

The I/O unit 1305 is configured to transmit and receive communications (e.g., commands, data, etc.) from a host processor (not shown) over the interconnect 1302. The I/O unit 1305 may communicate with the host processor directly via the interconnect 1302 or through one or more intermediate devices such as a memory bridge. In an embodiment, the I/O unit 1305 may communicate with one or more other processors, such as one or more the PPUs 1300 via the interconnect 1302. In an embodiment, the I/O unit 1305 implements a Peripheral Component Interconnect Express (PCIe) interface for communications over a PCIe bus and the interconnect 1302 is a PCIe bus. In alternative embodiments, the I/O unit 1305 may implement other types of well-known interfaces for communicating with external devices.

The I/O unit 1305 decodes packets received via the interconnect 1302. In an embodiment, the packets represent commands configured to cause the PPU 1300 to perform various operations. The I/O unit 1305 transmits the decoded commands to various other units of the PPU 1300 as the commands may specify. For example, some commands may be transmitted to the front end unit 1315. Other commands may be transmitted to the hub 1330 or other units of the PPU 1300 such as one or more copy engines, a video encoder, a video decoder, a power management unit, etc. (not explicitly shown). In other words, the I/O unit 1305 is configured to route communications between and among the various logical units of the PPU 1300.

In an embodiment, a program executed by the host processor encodes a command stream in a buffer that provides workloads to the PPU 1300 for processing. A workload may comprise several instructions and data to be processed by those instructions. The buffer is a region in a memory that is accessible (e.g., read/write) by both the host processor and the PPU 1300. For example, the I/O unit 1305 may be configured to access the buffer in a system memory connected to the interconnect 1302 via memory requests transmitted over the interconnect 1302. In an embodiment, the host processor writes the command stream to the buffer and then transmits a pointer to the start of the command stream to the PPU 1300. The front end unit 1315 receives pointers to one or more command streams. The front end unit 1315 manages the one or more streams, reading commands from the streams and forwarding commands to the various units of the PPU 1300.

The front end unit 1315 is coupled to a scheduler unit 1320 that configures the various GPCs 1350 to process tasks defined by the one or more streams. The scheduler unit 1320 is configured to track state information related to the various tasks managed by the scheduler unit 1320. The state may indicate which GPC 1350 a task is assigned to, whether the task is active or inactive, a priority level associated with the task, and so forth. The scheduler unit 1320 manages the execution of a plurality of tasks on the one or more GPCs 1350.

The scheduler unit 1320 is coupled to a work distribution unit 1325 that is configured to dispatch tasks for execution on the GPCs 1350. The work distribution unit 1325 may track a number of scheduled tasks received from the scheduler unit 1320. In an embodiment, the work distribution unit 1325 manages a pending task pool and an active task pool for each of the GPCs 1350. The pending task pool may comprise a number of slots (e.g., 32 slots) that contain tasks assigned to be processed by a particular GPC 1350. The active task pool may comprise a number of slots (e.g., 4 slots) for tasks that are actively being processed by the GPCs 1350. As a GPC 1350 finishes the execution of a task, that task is evicted from the active task pool for the GPC 1350 and one of the other tasks from the pending task pool is selected and scheduled for execution on the GPC 1350. If an active task has been idle on the GPC 1350, such as while waiting for a data dependency to be resolved, then the active task may be evicted from the GPC 1350 and returned to the pending task pool while another task in the pending task pool is selected and scheduled for execution on the GPC 1350.

The work distribution unit 1325 communicates with the one or more GPCs 1350 via XBar 1370. The XBar 1370 is an interconnect network that couples many of the units of the PPU 1300 to other units of the PPU 1300. For example, the XBar 1370 may be configured to couple the work distribution unit 1325 to a particular GPC 1350. Although not shown explicitly, one or more other units of the PPU 1300 may also be connected to the XBar 1370 via the hub 1330.

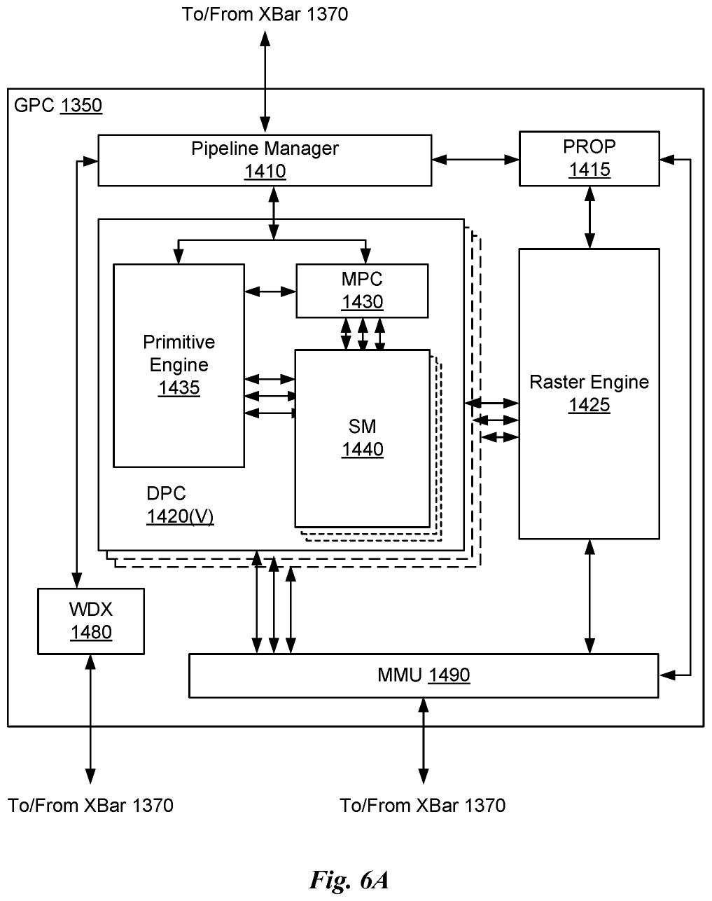

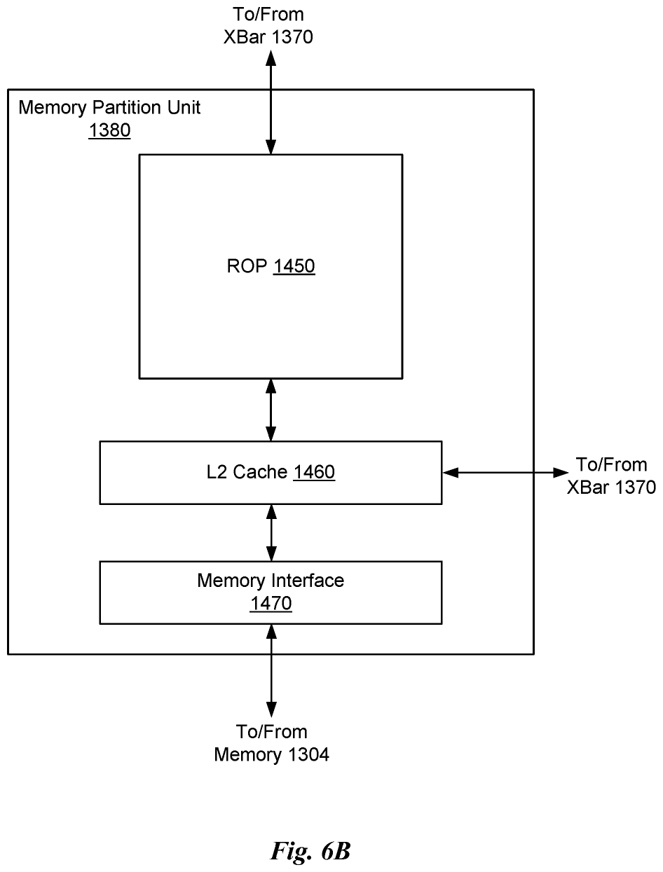

The tasks are managed by the scheduler unit 1320 and dispatched to a GPC 1350 by the work distribution unit 1325. The GPC 1350 is configured to process the task and generate results. The results may be consumed by other tasks within the GPC 1350, routed to a different GPC 1350 via the XBar 1370, or stored in the memory 1304. The results can be written to the memory 1304 via the memory partition units 1380, which implement a memory interface for reading and writing data to/from the memory 1304. The results can be transmitted to another PPU 1304 or CPU via the NVLink 1310. In an embodiment, the PPU 1300 includes a number U of memory partition units 1380 that is equal to the number of separate and distinct memory devices 1304 coupled to the PPU 1300. A memory partition unit 1380 will be described in more detail below in conjunction with FIG. 6B.

In an embodiment, a host processor executes a driver kernel that implements an application programming interface (API) that enables one or more applications executing on the host processor to schedule operations for execution on the PPU 1300. In an embodiment, multiple compute applications are simultaneously executed by the PPU 1300 and the PPU 1300 provides isolation, quality of service (QoS), and independent address spaces for the multiple compute applications. An application may generate instructions (e.g., API calls) that cause the driver kernel to generate one or more tasks for execution by the PPU 1300. The driver kernel outputs tasks to one or more streams being processed by the PPU 1300. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 7A.

FIG. 6A illustrates a GPC 1350 of the PPU 1300 of FIG. 5, in accordance with an embodiment. As shown in FIG. 6A, each GPC 1350 includes a number of hardware units for processing tasks. In an embodiment, each GPC 1350 includes a pipeline manager 1410, a pre-raster operations unit (PROP) 1415, a raster engine 1425, a work distribution crossbar (WDX) 1480, a memory management unit (MMU) 1490, and one or more Data Processing Clusters (DPCs) 1420. It will be appreciated that the GPC 1350 of FIG. 6A may include other hardware units in lieu of or in addition to the units shown in FIG. 6A.

In an embodiment, the operation of the GPC 1350 is controlled by the pipeline manager 1410. The pipeline manager 1410 manages the configuration of the one or more DPCs 1420 for processing tasks allocated to the GPC 1350. In an embodiment, the pipeline manager 1410 may configure at least one of the one or more DPCs 1420 to implement at least a portion of a graphics rendering pipeline. For example, a DPC 1420 may be configured to execute a vertex shader program on the programmable streaming multiprocessor (SM) 1440. The pipeline manager 1410 may also be configured to route packets received from the work distribution unit 1325 to the appropriate logical units within the GPC 1350. For example, some packets may be routed to fixed function hardware units in the PROP 1415 and/or raster engine 1425 while other packets may be routed to the DPCs 1420 for processing by the primitive engine 1435 or the SM 1440. In an embodiment, the pipeline manager 1410 may configure at least one of the one or more DPCs 1420 to implement a neural network model and/or a computing pipeline.

The PROP unit 1415 is configured to route data generated by the raster engine 1425 and the DPCs 1420 to a Raster Operations (ROP) unit, described in more detail in conjunction with FIG. 6B. The PROP unit 1415 may also be configured to perform optimizations for color blending, organize pixel data, perform address translations, and the like.

The raster engine 1425 includes a number of fixed function hardware units configured to perform various raster operations. In an embodiment, the raster engine 1425 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1425 comprises fragments to be processed, for example, by a fragment shader implemented within a DPC 1420.

Each DPC 1420 included in the GPC 1350 includes an M-Pipe Controller (MPC) 1430, a primitive engine 1435, and one or more SMs 1440. The MPC 1430 controls the operation of the DPC 1420, routing packets received from the pipeline manager 1410 to the appropriate units in the DPC 1420. For example, packets associated with a vertex may be routed to the primitive engine 1435, which is configured to fetch vertex attributes associated with the vertex from the memory 1304. In contrast, packets associated with a shader program may be transmitted to the SM 1440.

The SM 1440 comprises a programmable streaming processor that is configured to process tasks represented by a number of threads. Each SM 1440 is multi-threaded and configured to execute a plurality of threads (e.g., 32 threads) from a particular group of threads concurrently. In an embodiment, the SM 1440 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 1440 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 1440 will be described in more detail below in conjunction with FIG. 7A.

The MMU 1490 provides an interface between the GPC 1350 and the memory partition unit 1380. The MMU 1490 may provide translation of virtual addresses into physical addresses, memory protection, and arbitration of memory requests. In an embodiment, the MMU 1490 provides one or more translation lookaside buffers (TLBs) for performing translation of virtual addresses into physical addresses in the memory 1304.

FIG. 6B illustrates a memory partition unit 1380 of the PPU 1300 of FIG. 5, in accordance with an embodiment. As shown in FIG. 6B, the memory partition unit 1380 includes a Raster Operations (ROP) unit 1450, a level two (L2) cache 1460, and a memory interface 1470. The memory interface 1470 is coupled to the memory 1304. Memory interface 1470 may implement 32, 64, 128, 1024-bit data buses, or the like, for high-speed data transfer. In an embodiment, the PPU 1300 incorporates U memory interfaces 1470, one memory interface 1470 per pair of memory partition units 1380, where each pair of memory partition units 1380 is connected to a corresponding memory device 1304. For example, PPU 1300 may be connected to up to Y memory devices 1304, such as high bandwidth memory stacks or graphics double-data-rate, version 5, synchronous dynamic random access memory, or other types of persistent storage.

In an embodiment, the memory interface 1470 implements an HBM2 memory interface and Y equals half U. In an embodiment, the HBM2 memory stacks are located on the same physical package as the PPU 1300, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1304 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 1300 process very large datasets and/or run applications for extended periods.

In an embodiment, the PPU 1300 implements a multi-level memory hierarchy. In an embodiment, the memory partition unit 1380 supports a unified memory to provide a single unified virtual address space for CPU and PPU 1300 memory, enabling data sharing between virtual memory systems. In an embodiment the frequency of accesses by a PPU 1300 to memory located on other processors is traced to ensure that memory pages are moved to the physical memory of the PPU 1300 that is accessing the pages more frequently. In an embodiment, the NVLink 1310 supports address translation services allowing the PPU 1300 to directly access a CPU's page tables and providing full access to CPU memory by the PPU 1300.

In an embodiment, copy engines transfer data between multiple PPUs 1300 or between PPUs 1300 and CPUs. The copy engines can generate page faults for addresses that are not mapped into the page tables. The memory partition unit 1380 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1304 or other system memory may be fetched by the memory partition unit 1380 and stored in the L2 cache 1460, which is located on-chip and is shared between the various GPCs 1350. As shown, each memory partition unit 1380 includes a portion of the L2 cache 1460 associated with a corresponding memory device 1304. Lower level caches may then be implemented in various units within the GPCs 1350. For example, each of the SMs 1440 may implement a level one (L1) cache. The L1 cache is private memory that is dedicated to a particular SM 1440. Data from the L2 cache 1460 may be fetched and stored in each of the L1 caches for processing in the functional units of the SMs 1440. The L2 cache 1460 is coupled to the memory interface 1470 and the XBar 1370.

The ROP unit 1450 performs graphics raster operations related to pixel color, such as color compression, pixel blending, and the like. The ROP unit 1450 also implements depth testing in conjunction with the raster engine 1425, receiving a depth for a sample location associated with a pixel fragment from the culling engine of the raster engine 1425. The depth is tested against a corresponding depth in a depth buffer for a sample location associated with the fragment. If the fragment passes the depth test for the sample location, then the ROP unit 1450 updates the depth buffer and transmits a result of the depth test to the raster engine 1425. It will be appreciated that the number of memory partition units 1380 may be different than the number of GPCs 1350 and, therefore, each ROP unit 1450 may be coupled to each of the GPCs 1350. The ROP unit 1450 tracks packets received from the different GPCs 1350 and determines which GPC 1350 that a result generated by the ROP unit 1450 is routed to through the Xbar 1370. Although the ROP unit 1450 is included within the memory partition unit 1380 in FIG. 6B, in other embodiment, the ROP unit 1450 may be outside of the memory partition unit 1380. For example, the ROP unit 1450 may reside in the GPC 1350 or another unit.

FIG. 7A illustrates the streaming multi-processor 1440 of FIG. 6A, in accordance with an embodiment. As shown in FIG. 7A, the SM 1440 includes an instruction cache 1505, one or more scheduler units 1510, a register file 1520, one or more processing cores 1550, one or more special function units (SFUs) 1552, one or more load/store units (LSUs) 1554, an interconnect network 1580, a shared memory/L1 cache 1570.

As described above, the work distribution unit 1325 dispatches tasks for execution on the GPCs 1350 of the PPU 1300. The tasks are allocated to a particular DPC 1420 within a GPC 1350 and, if the task is associated with a shader program, the task may be allocated to an SM 1440. The scheduler unit 1510 receives the tasks from the work distribution unit 1325 and manages instruction scheduling for one or more thread blocks assigned to the SM 1440. The scheduler unit 1510 schedules thread blocks for execution as warps of parallel threads, where each thread block is allocated at least one warp. In an embodiment, each warp executes 32 threads. The scheduler unit 1510 may manage a plurality of different thread blocks, allocating the warps to the different thread blocks and then dispatching instructions from the plurality of different cooperative groups to the various functional units (e.g., cores 1550, SFUs 1552, and LSUs 1554) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 1515 is configured to transmit instructions to one or more of the functional units. In the embodiment, the scheduler unit 1510 includes two dispatch units 1515 that enable two different instructions from the same warp to be dispatched during each clock cycle. In alternative embodiments, each scheduler unit 1510 may include a single dispatch unit 1515 or additional dispatch units 1515.

Each SM 1440 includes a register file 1520 that provides a set of registers for the functional units of the SM 1440. In an embodiment, the register file 1520 is divided between each of the functional units such that each functional unit is allocated a dedicated portion of the register file 1520. In another embodiment, the register file 1520 is divided between the different warps being executed by the SM 1440. The register file 1520 provides temporary storage for operands connected to the data paths of the functional units.

Each SM 1440 comprises L processing cores 1550. In an embodiment, the SM 1440 includes a large number (e.g., 128, etc.) of distinct processing cores 1550. Each core 1550 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 1550 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 1550. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 1440 also comprises M SFUs 1552 that perform special functions (e.g., attribute evaluation, reciprocal square root, and the like). In an embodiment, the SFUs 1552 may include a tree traversal unit configured to traverse a hierarchical tree data structure. In an embodiment, the SFUs 1552 may include texture unit configured to perform texture map filtering operations. In an embodiment, the texture units are configured to load texture maps (e.g., a 2D array of texels) from the memory 1304 and sample the texture maps to produce sampled texture values for use in shader programs executed by the SM 1440. In an embodiment, the texture maps are stored in the shared memory/L1 cache 1470. The texture units implement texture operations such as filtering operations using mip-maps (e.g., texture maps of varying levels of detail). In an embodiment, each SM 1340 includes two texture units.

Each SM 1440 also comprises N LSUs 1554 that implement load and store operations between the shared memory/L1 cache 1570 and the register file 1520. Each SM 1440 includes an interconnect network 1580 that connects each of the functional units to the register file 1520 and the LSU 1554 to the register file 1520, shared memory/L1 cache 1570. In an embodiment, the interconnect network 1580 is a crossbar that can be configured to connect any of the functional units to any of the registers in the register file 1520 and connect the LSUs 1554 to the register file and memory locations in shared memory/L1 cache 1570.

The shared memory/L1 cache 1570 is an array of on-chip memory that allows for data storage and communication between the SM 1440 and the primitive engine 1435 and between threads in the SM 1440. In an embodiment, the shared memory/L1 cache 1570 comprises 128 KB of storage capacity and is in the path from the SM 1440 to the memory partition unit 1380. The shared memory/L1 cache 1570 can be used to cache reads and writes. One or more of the shared memory/L1 cache 1570, L2 cache 1460, and memory 1304 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1570 enables the shared memory/L1 cache 1570 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 1325 assigns and distributes blocks of threads directly to the DPCs 1420. The threads in a block execute the same program, using a unique thread ID in the calculation to ensure each thread generates unique results, using the SM 1440 to execute the program and perform calculations, shared memory/L1 cache 1570 to communicate between threads, and the LSU 1554 to read and write global memory through the shared memory/L1 cache 1570 and the memory partition unit 1380. When configured for general purpose parallel computation, the SM 1440 can also write commands that the scheduler unit 1320 can use to launch new work on the DPCs 1420.

The PPU 1300 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 1300 is embodied on a single semiconductor substrate. In another embodiment, the PPU 1300 is included in a system-on-a-chip (SoC) along with one or more other devices such as additional PPUs 1300, the memory 1304, a reduced instruction set computer (RISC) CPU, a memory management unit (MMU), a digital-to-analog converter (DAC), and the like.

In an embodiment, the PPU 1300 may be included on a graphics card that includes one or more memory devices 1304. The graphics card may be configured to interface with a PCIe slot on a motherboard of a desktop computer. In yet another embodiment, the PPU 1300 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 7B is a conceptual diagram of a processing system 1500 implemented using the PPU 1300 of FIG. 5, in accordance with an embodiment. The exemplary system 1565 may be configured to implement the method 100 shown in FIG. 1. The processing system 1500 includes a CPU 1530, switch 1510, and multiple PPUs 1300 each and respective memories 1304. The NVLink 1310 provides high-speed communication links between each of the PPUs 1300. Although a particular number of NVLink 1310 and interconnect 1302 connections are illustrated in FIG. 7B, the number of connections to each PPU 1300 and the CPU 1530 may vary. The switch 1510 interfaces between the interconnect 1302 and the CPU 1530. The PPUs 1300, memories 1304, and NVLinks 1310 may be situated on a single semiconductor platform to form a parallel processing module 1525. In an embodiment, the switch 1510 supports two or more protocols to interface between various different connections and/or links.

In another embodiment (not shown), the NVLink 1310 provides one or more high-speed communication links between each of the PPUs 1300 and the CPU 1530 and the switch 1510 interfaces between the interconnect 1302 and each of the PPUs 1300. The PPUs 1300, memories 1304, and interconnect 1302 may be situated on a single semiconductor platform to form a parallel processing module 1525. In yet another embodiment (not shown), the interconnect 1302 provides one or more communication links between each of the PPUs 1300 and the CPU 1530 and the switch 1510 interfaces between each of the PPUs 1300 using the NVLink 1310 to provide one or more high-speed communication links between the PPUs 1300. In another embodiment (not shown), the NVLink 1310 provides one or more high-speed communication links between the PPUs 1300 and the CPU 1530 through the switch 1510. In yet another embodiment (not shown), the interconnect 1302 provides one or more communication links between each of the PPUs 1300 directly. One or more of the NVLink 1310 high-speed communication links may be implemented as a physical NVLink interconnect or either an on-chip or on-die interconnect using the same protocol as the NVLink 1310.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1525 may be implemented as a circuit board substrate and each of the PPUs 1300 and/or memories 1304 may be packaged devices. In an embodiment, the CPU 1530, switch 1510, and the parallel processing module 1525 are situated on a single semiconductor platform.

In an embodiment, the signaling rate of each NVLink 1310 is 20 to 25 Gigabits/second and each PPU 1300 includes six NVLink 1310 interfaces (as shown in FIG. 7B, five NVLink 1310 interfaces are included for each PPU 1300). Each NVLink 1310 provides a data transfer rate of 25 Gigabytes/second in each direction, with six links providing 1300 Gigabytes/second. The NVLinks 1310 can be used exclusively for PPU-to-PPU communication as shown in FIG. 7B, or some combination of PPU-to-PPU and PPU-to-CPU, when the CPU 1530 also includes one or more NVLink 1310 interfaces.

In an embodiment, the NVLink 1310 allows direct load/store/atomic access from the CPU 1530 to each PPU's 1300 memory 1304. In an embodiment, the NVLink 1310 supports coherency operations, allowing data read from the memories 1304 to be stored in the cache hierarchy of the CPU 1530, reducing cache access latency for the CPU 1530. In an embodiment, the NVLink 1310 includes support for Address Translation Services (ATS), allowing the PPU 1300 to directly access page tables within the CPU 1530. One or more of the NVLinks 1310 may also be configured to operate in a low-power mode.

FIG. 7C illustrates an exemplary system 1565 in which the various architecture and/or functionality of the various previous embodiments may be implemented. The exemplary system 1565 may be configured to implement the method 100 shown in FIG. 1.

As shown, a system 1565 is provided including at least one central processing unit 1530 that is connected to a communication bus 1575. The communication bus 1575 may be implemented using any suitable protocol, such as PCI (Peripheral Component Interconnect), PCI-Express, AGP (Accelerated Graphics Port), HyperTransport, or any other bus or point-to-point communication protocol(s). The system 1565 also includes a main memory 1540. Control logic (software) and data are stored in the main memory 1540 which may take the form of random access memory (RAM).

The system 1565 also includes input devices 1560, the parallel processing system 1525, and display devices 1545, e.g. a conventional CRT (cathode ray tube), LCD (liquid crystal display), LED (light emitting diode), plasma display or the like. User input may be received from the input devices 1560, e.g., keyboard, mouse, touchpad, microphone, and the like. Each of the foregoing modules and/or devices may even be situated on a single semiconductor platform to form the system 1565. Alternately, the various modules may also be situated separately or in various combinations of semiconductor platforms per the desires of the user.

Further, the system 1565 may be coupled to a network (e.g., a telecommunications network, local area network (LAN), wireless network, wide area network (WAN) such as the Internet, peer-to-peer network, cable network, or the like) through a network interface 1535 for communication purposes.

The system 1565 may also include a secondary storage (not shown). The secondary storage 1610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1540 and/or the secondary storage. Such computer programs, when executed, enable the system 1565 to perform various functions. The memory 1540, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1565 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

In an embodiment, the PPU 1300 comprises a graphics processing unit (GPU). The PPU 1300 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 1300 can be configured to process the graphics primitives to generate a frame buffer (e.g., pixel data for each of the pixels of the display).

An application writes model data for a scene (e.g., a collection of vertices and attributes) to a memory such as a system memory or memory 1304. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the SMs 1440 of the PPU 1300 including one or more of a vertex shader, hull shader, domain shader, geometry shader, and a pixel shader. For example, one or more of the SMs 1440 may be configured to execute a vertex shader program that processes a number of vertices defined by the model data. In an embodiment, the different SMs 1440 may be configured to execute different shader programs concurrently. For example, a first subset of SMs 1440 may be configured to execute a vertex shader program while a second subset of SMs 1440 may be configured to execute a pixel shader program. The first subset of SMs 1440 processes vertex data to produce processed vertex data and writes the processed vertex data to the L2 cache 1460 and/or the memory 1304. After the processed vertex data is rasterized (e.g., transformed from three-dimensional data into two-dimensional data in screen space) to produce fragment data, the second subset of SMs 1440 executes a pixel shader to produce processed fragment data, which is then blended with other processed fragment data and written to the frame buffer in memory 1304. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

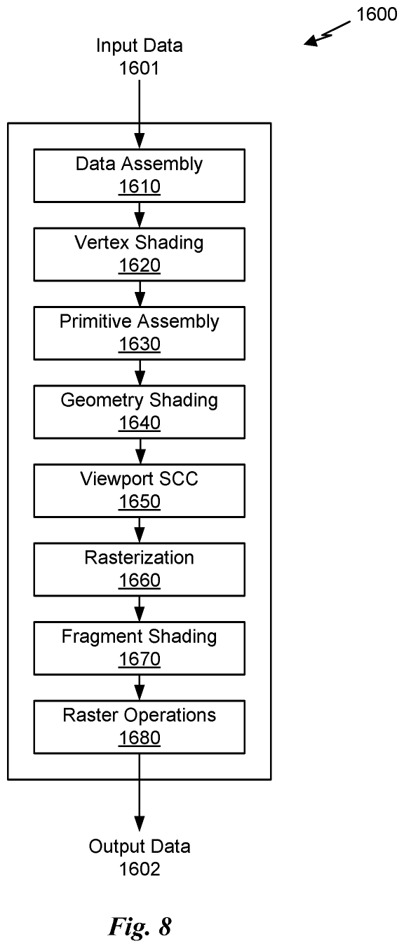

FIG. 8 is a conceptual diagram of a graphics processing pipeline 1600 implemented by the PPU 1300 of FIG. 5, in accordance with an embodiment. The graphics processing pipeline 1600 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 1600 receives input data 1601 that is transmitted from one stage to the next stage of the graphics processing pipeline 1600 to generate output data 1602. In an embodiment, the graphics processing pipeline 1600 may represent a graphics processing pipeline defined by the OpenGL® API. As an option, the graphics processing pipeline 1600 may be implemented in the context of the functionality and architecture of the previous Figures and/or any subsequent Figure(s).

As shown in FIG. 8, the graphics processing pipeline 1600 comprises a pipeline architecture that includes a number of stages. The stages include, but are not limited to, a data assembly stage 1610, a vertex shading stage 1620, a primitive assembly stage 1630, a geometry shading stage 1640, a viewport scale, cull, and clip (VSCC) stage 1650, a rasterization stage 1660, a fragment shading stage 1670, and a raster operations stage 1680. In an embodiment, the input data 1601 comprises commands that configure the processing units to implement the stages of the graphics processing pipeline 1600 and geometric primitives (e.g., points, lines, triangles, quads, triangle strips or fans, etc.) to be processed by the stages. The output data 1602 may comprise pixel data (e.g., color data) that is copied into a frame buffer or other type of surface data structure in a memory.

The data assembly stage 1610 receives the input data 1601 that specifies vertex data for high-order surfaces, primitives, or the like. The data assembly stage 1610 collects the vertex data in a temporary storage or queue, such as by receiving a command from the host processor that includes a pointer to a buffer in memory and reading the vertex data from the buffer. The vertex data is then transmitted to the vertex shading stage 1620 for processing.

The vertex shading stage 1620 processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 1620 may manipulate individual vertex attributes such as position, color, texture coordinates, and the like. In other words, the vertex shading stage 1620 performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 1620 generates transformed vertex data that is transmitted to the primitive assembly stage 1630.

The primitive assembly stage 1630 collects vertices output by the vertex shading stage 1620 and groups the vertices into geometric primitives for processing by the geometry shading stage 1640. For example, the primitive assembly stage 1630 may be configured to group every three consecutive vertices as a geometric primitive (e.g., a triangle) for transmission to the geometry shading stage 1640. In some embodiments, specific vertices may be reused for consecutive geometric primitives (e.g., two consecutive triangles in a triangle strip may share two vertices). The primitive assembly stage 1630 transmits geometric primitives (e.g., a collection of associated vertices) to the geometry shading stage 1640.

The geometry shading stage 1640 processes geometric primitives by performing a set of operations (e.g., a geometry shader or program) on the geometric primitives. Tessellation operations may generate one or more geometric primitives from each geometric primitive. In other words, the geometry shading stage 1640 may subdivide each geometric primitive into a finer mesh of two or more geometric primitives for processing by the rest of the graphics processing pipeline 1600. The geometry shading stage 1640 transmits geometric primitives to the viewport SCC stage 1650.

In an embodiment, the graphics processing pipeline 1600 may operate within a streaming multiprocessor and the vertex shading stage 1620, the primitive assembly stage 1630, the geometry shading stage 1640, the fragment shading stage 1670, and/or hardware/software associated therewith, may sequentially perform processing operations. Once the sequential processing operations are complete, in an embodiment, the viewport SCC stage 1650 may utilize the data. In an embodiment, primitive data processed by one or more of the stages in the graphics processing pipeline 1600 may be written to a cache (e.g. L1 cache, a vertex cache, etc.). In this case, in an embodiment, the viewport SCC stage 1650 may access the data in the cache. In an embodiment, the viewport SCC stage 1650 and the rasterization stage 1660 are implemented as fixed function circuitry.

The viewport SCC stage 1650 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization stage 1660.

The rasterization stage 1660 converts the 3D geometric primitives into 2D fragments (e.g. capable of being utilized for display, etc.). The rasterization stage 1660 may be configured to utilize the vertices of the geometric primitives to setup a set of plane equations from which various attributes can be interpolated. The rasterization stage 1660 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 1660 generates fragment data (e.g., interpolated vertex attributes associated with a particular sample location for each covered pixel) that are transmitted to the fragment shading stage 1670.

The fragment shading stage 1670 processes fragment data by performing a set of operations (e.g., a fragment shader or a program) on each of the fragments. The fragment shading stage 1670 may generate pixel data (e.g., color values) for the fragment such as by performing lighting operations or sampling texture maps using interpolated texture coordinates for the fragment. The fragment shading stage 1670 generates pixel data that is transmitted to the raster operations stage 1680.

The raster operations stage 1680 may perform various operations on the pixel data such as performing alpha tests, stencil tests, and blending the pixel data with other pixel data corresponding to other fragments associated with the pixel. When the raster operations stage 1680 has finished processing the pixel data (e.g., the output data 1602), the pixel data may be written to a render target such as a frame buffer, a color buffer, or the like.

It will be appreciated that one or more additional stages may be included in the graphics processing pipeline 1600 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 1640). Other types of graphics processing pipelines are contemplated as being within the scope of the present disclosure. Furthermore, any of the stages of the graphics processing pipeline 1600 may be implemented by one or more dedicated hardware units within a graphics processor such as PPU 1300. Other stages of the graphics processing pipeline 1600 may be implemented by programmable hardware units such as the SM 1440 of the PPU 1300.

The graphics processing pipeline 1600 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 1300. The API provides an abstraction for a programmer that lets a programmer utilize specialized graphics hardware, such as the PPU 1300, to generate the graphical data without requiring the programmer to utilize the specific instruction set for the PPU 1300. The application may include an API call that is routed to the device driver for the PPU 1300. The device driver interprets the API call and performs various operations to respond to the API call. In some instances, the device driver may perform operations by executing instructions on the CPU. In other instances, the device driver may perform operations, at least in part, by launching operations on the PPU 1300 utilizing an input/output interface between the CPU and the PPU 1300. In an embodiment, the device driver is configured to implement the graphics processing pipeline 1600 utilizing the hardware of the PPU 1300.

Various programs may be executed within the PPU 1300 in order to implement the various stages of the graphics processing pipeline 1600. For example, the device driver may launch a kernel on the PPU 1300 to perform the vertex shading stage 1620 on one SM 1440 (or multiple SMs 1440). The device driver (or the initial kernel executed by the PPU 1400) may also launch other kernels on the PPU 1400 to perform other stages of the graphics processing pipeline 1600, such as the geometry shading stage 1640 and the fragment shading stage 1670. In addition, some of the stages of the graphics processing pipeline 1600 may be implemented on fixed unit hardware such as a rasterizer or a data assembler implemented within the PPU 1400. It will be appreciated that results from one kernel may be processed by one or more intervening fixed function hardware units before being processed by a subsequent kernel on an SM 1440.

### Machine Learning

Deep neural networks (DNNs) developed on processors, such as the PPU 1300 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 1300. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 1300 is a computing platform capable of delivering performance required for deep neural network-based artificial intelligence and machine learning applications.

1. A system, comprising:
a processor to use one or more machine learning models to adjust one or more visual sensors to optimize visual sensing of the one or more visual sensors.

2. The system of claim 1, further comprising using the processor to determine environmental conditions based at least in part on receiving one or more visual sensor inputs from the one or more visual sensors.

3. The system of claim 2, wherein the one or more visual sensors include one or more cameras.

4. The system of claim 2, wherein the one or more visual sensor inputs include at least one of: one or more images of an environment surrounding the one or more visual sensors or one or more video frames of an environment surrounding the one or more visual sensors.

5. The system of claim 2, wherein using the processor to determine the environmental conditions includes:
inputting the one or more visual sensor inputs to the one or more machine learning models, and
receiving as output from the one or more machine learning models the environmental conditions.

6. The system of claim 5, wherein the one or more machine learning models are trained using training data to learn environmental conditions from visual sensor inputs.

7. The system of claim 2, wherein the environmental conditions include a state of an environment surrounding the one or more visual sensors.

8. The system of claim 1, wherein adjusting the one or more visual sensors comprises changing the one or more visual sensors from a current position to a determined position.

9. The system of claim 1, wherein causing the one or more visual sensors to adjust includes causing the one or more visual sensors to change position rotationally.

10. The system of claim 1, wherein causing the one or more visual sensors to adjust includes causing the one or more visual sensors to change position linearly.

11. A non-transitory computer readable medium storing computer code executable by at least one processor to perform a method comprising:
adjusting, by using one or more machine learning models, one or more visual sensors to optimize visual sensing of the one or more visual sensors.

12. The non-transitory computer readable medium of claim 11, wherein the machine learning models are utilized to determine environmental conditions based at least in part on one or more visual sensor inputs received from the one or more visual sensors.

13. The non-transitory computer readable medium of claim 12, wherein visual information of the environmental conditions is displayed to a user.

14. The non-transitory computer readable medium of claim 13, wherein the visual information is output to an automated system that makes a decision based at least in part on the visual information.

15. A method, comprising:
using one or more machine learning models to adjust one or more visual sensor inputs to optimize visual sensing of the one or more visual sensors.

16. The method of claim 15, wherein causing the one or more visual sensors to adjust includes changing the one or more visual sensors from a current position to an optimal position and includes causing the one or more visual sensors to change linearly with respect to the current position.

17. The method of claim 16, wherein causing the one or more visual sensors to change from the current position to the optimal position includes causing the one or more visual sensors to change rotationally with respect to the current position.

18. The method of claim 15, further comprising using the one or more machine learning model, by a vehicle, to determine visual information of wherein the environmental conditions surrounding the vehicle.

19. The method of claim 18, wherein the visual information of the environmental conditions is displayed to a driver of the vehicle.

20. The method of claim 18, wherein the visual information is output to an automated driving system of the vehicle for use in making an automated driving decision.
